(19) United States
(12) Patent Application Publication
(10) Pub. No.: US 2016/0072420 A1
(43) Pub. Date: Mar. 10, 2016

(54) GENERATOR WITH POWER OUTPUT DURING ENGINE IDLE

(71) Applicant: Briggs & Stratton Corporation, Wauwatosa, WI (US)

(72) Inventors: Kenny J. Stair, North Prairie, WI (US); Sean J. Momsen, Mukwonago, WI (US); Ryan S. Jaskowiak, Eagle, WI (US); David C. Flegel, Watertown, WI (US); William E. Laudolff, Oak Creek, WI (US); Nicole R. Ewald, Waukesha, WI (US); Mark D. Willer, Brookfield, WI (US)

(21) Appl. No.: 14/850,362

(22) Filed: Sep. 10, 2015

Related U.S. Application Data
(60) Provisional application No. 62/048,386, filed on Sep. 10, 2014.

(51) Int. Cl. H02P 9/48; H02P 9/26

(52) U.S. Cl. CPC H02P 9/48; H02P 9/26

(57) ABSTRACT

A generator includes an engine, an alternator coupled to the engine for providing power to a load, a controller coupled to the engine for operating the engine at a run speed and an idle speed, and a converter coupled to the alternator for converting a voltage provided by the alternator from a first frequency to a second frequency to power the load when the engine is operating at the idle speed.

The present application claims priority from co-pending U.S. Provisional Patent Application Ser. No. 62/048,386 filed on Sep. 10, 2014 and entitled GENERATOR WITH POWER OUTPUT DURING ENGINE IDLE, the full disclosure of which is hereby incorporated by reference.

### BACKGROUND

Generators, such as portable generators, are used to supply electrical power in, for example, locations where access to conventional electrical utility infrastructure is inconvenient, inaccessible, or unavailable. Similarly, standby generators are used in situations when conventional electrical utility service has been rendered temporarily unavailable, such as during a power outage caused by severe weather. Generators typically include an alternator coupled to and driven by the output shaft of an internal combustion engine. The internal combustion engine rotates a rotor in the alternator, which in turn induces an electrical current in a set of wire coils in the stator of the alternator. The electrical current output from the alternator is typically an alternating current used to provide electrical power having characteristics similar or equivalent to conventional electrical utility service.

The internal combustion engine of a generator is typically operated at a regulated or governed run speed when the generator is used to power a normal load. When the load is disconnected, the generator may detect the change and switch the operating speed of the internal combustion engine from the run speed to a lower idle speed in order to save fuel and reduce noise levels. While the internal combustion engine is operating at the idle speed, however, no power is available from the generator. To power even a relatively small load, the internal combustion engine of the generator must be revved up to its run speed. There is need for a generator that is capable of providing power to smaller loads while its engine is operated at an idle speed in order to prevent inefficient fuel consumption and excessive noise.

### SUMMARY

In one embodiment, a generator includes an engine, an alternator coupled to the engine for providing power to a load, a controller coupled to the engine for operating the engine at a run speed and an idle speed, and a converter coupled to the alternator for converting the voltage provided by the alternator from a first frequency to a second frequency to power the load when the engine is operating at the idle speed.

In another embodiment, a method includes operating an engine of a generator at a run speed to provide power from an alternator to a load, switching from operating the engine at the run speed to operating the engine at an idle speed based on a detected change to the load, and converting a voltage provided by the alternator from a first frequency to a second frequency to power the load when the engine is operated at the idle speed.

In another embodiment, a method includes operating an engine of a generator at an idle speed, converting a voltage provided by an alternator coupled to the engine to power a load from a first frequency to a second frequency while the generator is operated at the idle speed, switching from operating the engine at the idle speed to operating the engine at a run speed based on a detected change to the load, and discontinuing conversion of the voltage from the first frequency to the second frequency when the engine is operated at the run speed.

### BRIEF DESCRIPTION OF THE DRAWINGS

FIG. 1 is a block diagram of an example generator.

FIG. 2 is a block diagram of a more detailed example of the generator of FIG. 1.

FIG. 3 is block diagram of another more detailed example of the generator of FIG. 1.

FIG. 4 is a flow diagram of an example process for operating the generator of FIG. 1.

FIG. 5 is a flow diagram of another example process for operating the generator of FIG. 1.

### DETAILED DESCRIPTION

According to various examples described herein, a generator, such as a portable or standby generator, may include an engine. The engine may be, for example, an internal combustion engine that operates on, for example, diesel fuel, gasoline, propane, natural gas, kerosene etc. The generator may also include an alternator coupled to the engine for providing power to loads, including, for example, larger loads such as power tools or home appliances, and smaller loads, such as alarm clocks, battery chargers, lights, etc. A controller may be coupled to the engine for operating the engine at, for example, a higher run speed and a lower idle speed based on changes to the load. For example, the controller may detect when the amount of power provided to the load exceeds or falls below a predetermined wattage. If the amount of power provided to the load falls below the predetermined wattage, then the controller may switch from operating the engine at a higher run speed to operating the engine at a lower idle speed. A converter may be coupled to the alternator for converting a voltage provided by the alternator from a lower frequency to a higher frequency to power the load when the engine is operating at the idle speed. For example, the alternator may provide a voltage at a higher frequency when the engine is operated at the run speed, and a voltage at a lower frequency when the engine is operated at the idle speed. The converter may include, for example, an inverter that converts the lower frequency voltage to a higher frequency voltage when the engine is operated at the idle speed.

In this way, the controller and the converter may provide the generator with a lower maximum power rating when the engine is operated at the idle speed and a higher maximum power rating when engine is operated at the run speed. Thus, the engine of the generator need not be revved up to its run speed in order to power smaller loads. This, in turn, may prevent inefficient fuel consumption and excessive noise when the generator is used to power smaller loads.

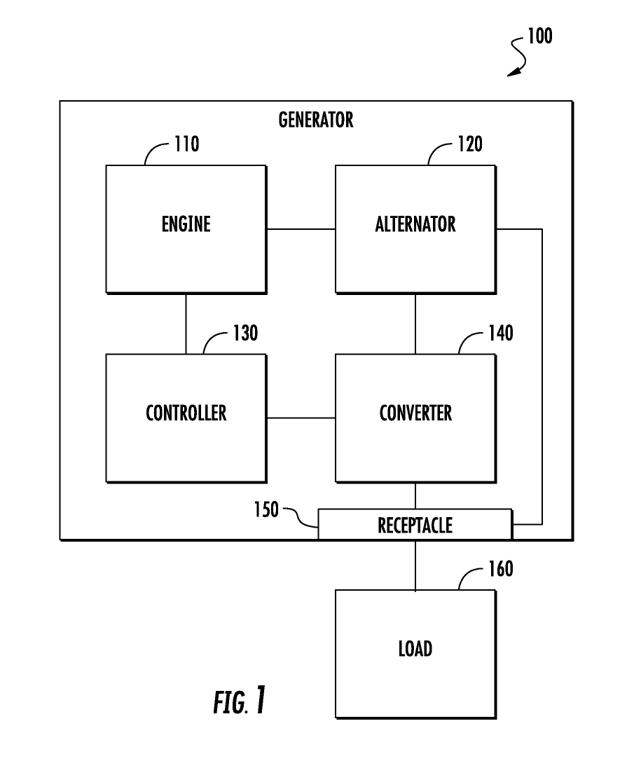

FIG. 1 is a block diagram of an example generator 100. Generator 100 may be any type of generator, such as portable generator, a standby generator, etc. adapted to implement the functionality disclosed herein. By way of example, generator 100 may be a residential or commercial portable generator such as a 6250 Watt Storm Responder Portable Generator manufactured by Briggs & Stratton, the assignee of the present application. Generator 100 may also be any size and/or provide any amount of wattage depending on the particular application, and may vary based on, for example, rated engine output, rated alternator output, etc.

As shown in FIG. 1, generator 100 may include an engine 110, an alternator 120, a controller 130, a converter 140, and a receptacle 150. An electrical load 160 may be connected to generator 100 via receptacle 150. Engine 110 may be, for example, an internal combustion engine. Engine 110 may operate on, for example, diesel fuel, gasoline, propane, natural gas, etc. Engine 110 may provide rotational mechanical energy via an output shaft to alternator 120, which may be rotationally coupled to the output shaft. Specifically, alternator 120 may include a rotor that, when rotationally driven by mechanical energy from engine 110, induces an alternating (AC) electrical current in a set of wire coils in the stator of the alternator, resulting in an AC voltage that may be applied across terminals of receptacle 150. The AC voltage may have characteristics similar or equivalent to a conventional electrical utility service, such as 120 VAC at 60 Hz as commonly used in the United States. When generator 100 is coupled to load 160, alternator 120 may provide power to load 160 by outputting an AC current at a corresponding AC voltage. Given that the AC current and AC voltage may typically be out of phase, the maximum rated output power of generator 100 may be stated in terms of a particular amount of wattage (e.g., 6250 Watts).

Controller 130 may be an electrical device, processing electronics, and/or an electromechanical device electrically and/or mechanically coupled to engine 110 to control the speed of engine 110. In particular, controller 130 may include an electrical and/or mechanical regulator or governor to switch from operating engine 110 at a run speed to operating engine 110 at an idle speed that is lower than the run speed based on a detected change to load 160. The idle and run speeds may be selected depending on the particular application, and may vary based on such factors as, for example, emissions requirements, engine balance, engine speed and acceleration capabilities, etc. Typical idle speeds may include engine speeds under, for example, 3600 revolutions per minute (RPM).

For example, controller 130 may regulate the speed of engine 110 at a run speed of 3600 RPM when load 160 maintains or exceeds a current draw of 500 mA, and may switch to regulating the speed of engine 110 at an idle speed of 2100 RPM if load 160 draws less than 500 mA of current. Controller 130 may detect changes to load 160 using, for example, a current transformer, to determine changes to the amount of current or wattage provided to load 160. For example, controller 130 may use a current transformer to detect when the amount of power provided to load 160 exceeds or falls below a predetermined wattage. If the amount of power provided to load 160 falls below, for example, 1000 Watts, then controller 130 may switch from operating engine 110 at a run speed to operating engine 110 at an idle speed. If the amount of power provided to load 160 equals or exceeds 1000 watts, controller 130 may switch from operating engine 110 at an idle speed to operating engine 110 at a run speed. In some examples, controller 130 may detect when the amount of power provided to load 160 exceeds or falls below a wattage included among multiple predetermined wattages corresponding to multiple different idle speeds. For example, if the amount of power provided to load 160 falls below, for example, 750 Watts, then controller 130 may switch from operating engine 110 at an idle speed of 2100 RPM to operating engine 110 at an idle speed lower than 2100 RPM. If the amount of power provided to load 160 equals or exceeds 750 watts, controller 130 may switch from operating engine 110 at an idle speed lower than 2100 RPM to operating engine 110 at an idle speed of 2100 RPM.

Converter 140 may be an electrical device that may be electrically coupled to controller 130 and/or alternator 120 in order to convert a voltage provided by alternator 120 from, for example, a lower frequency to a higher frequency, in order to power load 160 when engine 110 is operating at an idle speed. Converter 140 may include, for example, an inverter, a cycloconverter (CCV), a DC generator, a full wave or half wave bridge, processing electronics to provide controlled conversion steps, or a combination thereof that converts an AC voltage provided by alternator 120 at a first frequency into a direct current (DC) voltage and then back to an AC voltage at a second frequency. By way of example, alternator 120 may provide a 120 VAC voltage at 60 Hz when engine 110 is operated at a run speed of 3600 RPM, and a 120 VAC voltage at 40-45 Hz when engine 110 is operated at an idle speed of 2100 RPM. Converter 140 may include an inverter that converts the 40-45 Hz AC voltage to a DC voltage, and then to a 120 VAC voltage at 60 Hz when engine 110 is operated at the idle speed of 2100 RPM. Converter 140 may also discontinue converting the voltage provided by alternator 120 from the lower frequency to the higher frequency when engine 110 is operated at a run speed. Although the examples described herein are primarily described in the context of 120 VAC voltage at 60 Hz, it will be appreciated that other voltages and frequencies are contemplated as well. For example, converter 140 may be used with 115 VAC or 230 VAC, 50 Hz nominal European voltages and applications.

Controller 130 and converter 140 may operate together to provide generator 100 with a lower maximum power rating when engine 110 is operated at an idle speed and a higher maximum power rating when engine 110 is operated at a run speed. The lower and higher maximum power ratings for idle and run speeds may vary depending on the particular application and based on factors such as the rated output of engine 110, the rated output of alternator 120, the rated output of converter 140, etc. For example, controller 130 may determine if the amount of power provided to load 160 is below, for example, 1000 Watts. If so, controller 130 may switch from operating engine 110 at a run speed of 3600 RPM to operating engine 110 at an idle speed of 2100 RPM. Alternator 120 may provide a 120 VAC voltage at 60 Hz when engine 110 is operated at the run speed of 3600 RPM, and a 120 VAC voltage at only 40-45 Hz when engine 110 is operated at the idle speed of 2100 RPM. Converter 140 may include an inverter that converts the 40-45 Hz AC voltage to a DC voltage, and then to a 120 VAC voltage at 60 Hz when engine 110 is operated at the idle speed of 2100 RPM. Accordingly, generator 100 may provide load 160 with up to 1000 W of power at a voltage of 120 VAC and 60 Hz when engine 110 is operated at the idle speed of 2100 RPM.

Converter 140 may also discontinue converting the voltage provided by alternator 120 from the lower frequency to the higher frequency when engine 110 is operated at the run speed of 3600 RPM. That is, if controller 130 determines that the amount of power provided to load 160 exceeds 1000 Watts, controller 130 may switch from operating engine 110 at the idle speed of 2100 RPM to operating engine 110 at the run speed of 3600 RPM. Alternator 120 may then provide a 120 VAC voltage at 60 Hz when engine 110 is operated at the run speed of 3600 RPM such that voltage conversion is not required, and the full maximum rated power output of generator 100 is available.

In this way, controller 130 and converter 140 may provide generator 100 with a lower maximum power rating of, for example, 1000 Watts when engine 110 is operated at the idle speed of 2100 RPM. As such, the engine of the generator need not be revved up to its run speed of, for example, 3600 RPM in order to power smaller loads. As such, controller 130 and converter 140 may prevent inefficient fuel consumption and enable low cost operation of generator 100 for loads under 1000 Watts. At the same time, controller 130 and converter 140 may provide for quiet operation of generator 100 for loads under 1000 Watts by reducing the speed of engine 110 in order to eliminate excessive noise. For loads above 1000 Watts, controller 130 and converter 140 may provide generator 100 with a higher maximum power rating by operating engine 110 at the run speed.

Receptacle 150 may vary in configuration based on a particular application and/or may be designed for particular loads 160 including, for example, larger loads such as power tools or home appliances, and smaller loads, such as alarm clocks, battery chargers, lights, etc. Generator 100 may include residential or commercial grade receptacles 150 designed for use with 120 VAC or 240 VAC applications, and/or 15 Amp, 20 Amp, 30 Amp, 50 Amp devices, etc. Receptacle 150 also may be configured to receive electrical plugs designed for use in various countries or regions (e.g., 115 VAC or 230 VAC, 50 Hz nominal European voltages). In some examples, generator 100 may also include receptacles 150 designed for DC applications, such as 12 VDC applications. For example, converter 140 may provide a DC output voltage in addition to an AC voltage. The DC output voltage may be coupled to a receptacle 150 for purposes of powering, for example, 12 VDC loads at idle speed.

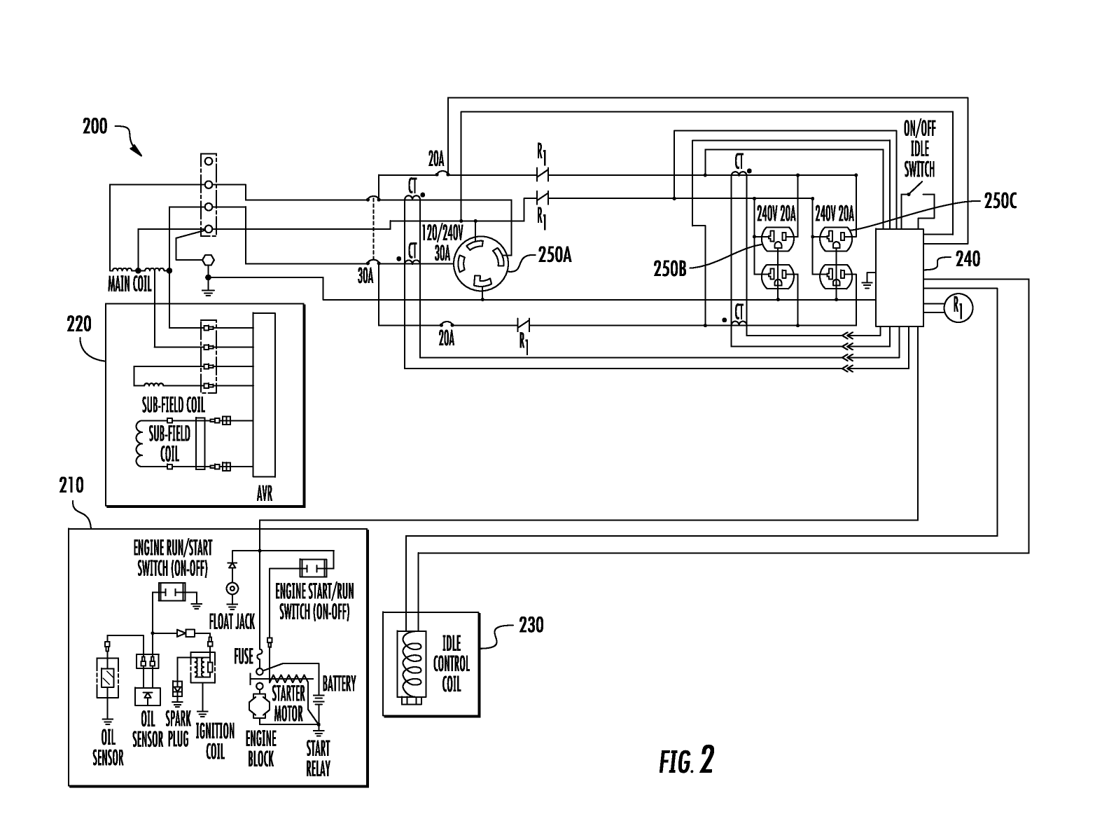

The number of receptacles 150 may vary as well as the number of receptacles that are controlled by converter 140. For example, FIG. 2 is a block diagram of a detailed example generator 200. Generator 200 is similar to generator 100 shown in FIG. 1. Generator 200 includes an engine 210, an alternator 220, a controller 230, a converter 240, and three receptacles 250a, 250b, and 250c. Receptacle 250a is designed for use with 120/240 VAC and 30 Amp applications. Receptacles 250b and 250c are designed for use with 120V and 20 Amp applications. Receptacles 250a, 250b and 250c are also controlled by converter 240 such that they provide power at a lower maximum power rating when engine 210 is operated at an idle speed and a higher maximum power rating when engine 210 is operated at a run speed.

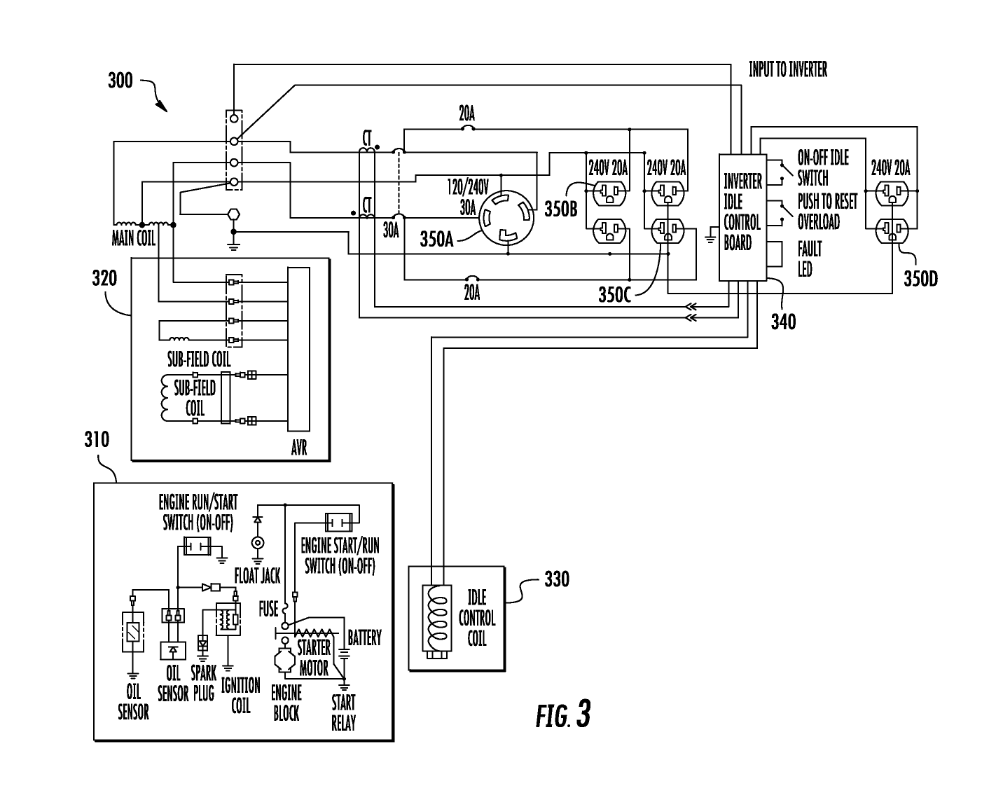

While the example generator 200 shown FIG. 2 includes multiple receptacles 250a, 250b and 250c that are each controlled by converter 240 such that they provide power at a lower maximum power rating when engine 210 is operated at an idle speed and a higher maximum power rating when engine 210 is operated at a run speed, other configurations are contemplated as well. For example, FIG. 3 is a block diagram of a detailed example generator 300. Generator 300 is also similar to generator 100 shown in FIG. 1, but is slightly different than generator 200 shown in FIG. 2. Generator 300 includes an engine 310, an alternator 320, a controller 330, a converter 340, and four receptacles 350a, 350b, 350c and 350d. Receptacle 350a is designed for use with 120/240 VAC and 30 Amp applications. Receptacles 350b, 350c, and 350d are designed for use with 120V and 20 Amp applications. Receptacles 350a, 350b and 350c are also controlled by converter 340 such that they provide power at a lower maximum power rating when engine 310 is operated at an idle speed and a higher maximum power rating when engine 310 is operated at a run speed. Receptacle 350d, however, is dedicated to converter 340 and is limited by converter 340 to the lower maximum power rating regardless of the engine speed.

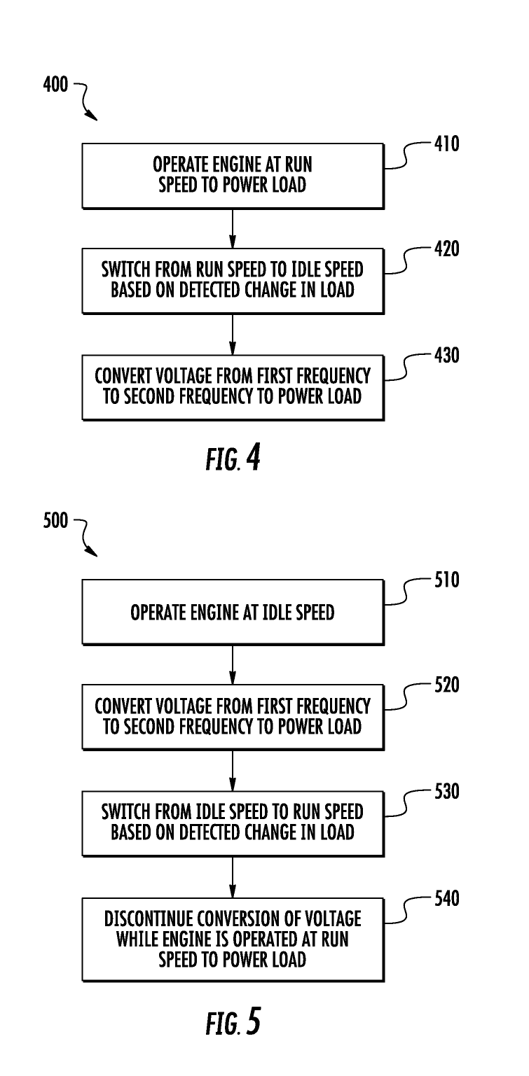

FIG. 4 is a flow diagram of an example process 400 for operating the generator of FIG. 1. At a step 410 an engine of a generator may be operated at a run speed to provide power from an alternator to a load. At a step 420, the engine may be switched from operating at the run speed to operating the engine at an idle speed based on a detected change to the load. At a step 430, a voltage provided by the alternator may be converted from a first frequency to a second frequency to power the load when the engine is operated at the idle speed.

FIG. 5 is a flow diagram of another example process for operating the generator of FIG. 1. At a step 510, an engine of a generator may be operated at an idle speed. At a step 520, a voltage provided by an alternator coupled to the generator to power a load may be converted from a first frequency to a second frequency while the generator is operated at the idle speed. At a step 530, the engine may be switched from operating at the idle speed to operating at a run speed based on a detected change in the load. At a step 540, conversion of the voltage from the first frequency to the second frequency may be discontinued when the engine is operated at the run speed.

For purposes of this application, processing electronics may include, for example, a processing unit configured to execute logic in the form of software instruction modules contained in a memory. The term “processing unit” shall mean a presently developed or future developed processing unit that executes sequences of instructions contained in a memory. The instructions may be loaded in a random access memory (RAM) for execution by the processing unit from a read only memory (ROM), a mass storage device, or some other persistent storage. In some examples, hardwired circuitry modules may be used in place of or in combination with software instruction modules to implement the functionality described herein. Unless otherwise specifically noted, the term processing electronics is not limited to any specific combination of hardware circuitry modules and software instruction modules, nor to any particular source for the instructions executed by the processing unit. Memory may include a non-transitory computer-readable medium. The term “non-transitory computer-readable medium” as used herein includes any computer readable medium, excluding only transitory propagating signals per se. Memory may include, for example any non-volatile or volatile memory such as DRAM, RAM, ROM, register memory, or some combination of these; for example a hard disk combined with RAM. Memory may store instructions for execution by a processing unit. In some examples, memory may further store data for use by a processing unit. Memory may store various software or code modules that direct a processing unit to carry out various interrelated actions.

It is important to note that the construction and arrangement of the generator with power output during engine idle as described herein is illustrative only. Although only a few embodiments of the present inventions have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements and vice versa, the position of elements may be reversed or otherwise varied, and the nature or number of discrete elements or positions may be altered or varied. Accordingly, all such modifications are intended to be included within the scope of the present invention as defined in the appended claims. The order or sequence of any process or method steps may be varied or re-sequenced according to alternative embodiments. Other substitutions, modifications, changes and omissions may be made in the design, operating conditions and arrangement of the exemplary embodiments without departing from the scope of the present inventions as expressed in the appended claims.

What is claimed is:

1. A generator, comprising:
an engine;
an alternator coupled to the engine for providing power to a load;
a controller coupled to the engine for operating the engine at a run speed and an idle speed; and
a converter coupled to the alternator for converting a voltage provided by the alternator from a first frequency to a second frequency to power the load when the engine is operating at the idle speed.

2. The generator of claim 1, wherein the generator is one of a portable generator and a standby generator.

3. The generator of claim 1, wherein the engine is an internal combustion engine that operates on one of diesel fuel, gasoline, propane, kerosene, and natural gas.

4. The generator of claim 1, wherein the controller switches the engine speed between the run speed and the idle speed based on changes to the load.

5. The generator of claim 1, wherein the generator has a first maximum power rating when the engine is operating at the idle speed and a second maximum power rating when the engine is operating at the run speed, and wherein the second maximum power rating is higher than the first maximum power rating.

6. The generator of claim 5, further comprising a receptacle for providing the power to the load, wherein receptacle is limited by the converter to the first maximum power rating regardless of the engine speed.

7. The generator of claim 1, wherein the converter includes an inverter.

8. The generator of claim 1, wherein the first frequency is lower than the second frequency.

9. A method, comprising:
operating an engine of a generator at a run speed to provide power from an alternator to a load;
switching from operating the engine at the run speed to operating the engine at an idle speed based on a detected change to the load; and
converting a voltage provided by the alternator from a first frequency to a second frequency to power the load when the engine is operated at the idle speed.

10. The method of claim 9, wherein the generator is one of a portable generator and a standby generator.

11. The method of claim 9, wherein the engine is an internal combustion engine operating on one of diesel fuel, gasoline, propane, kerosene, and natural gas.

12. The method of claim 9, wherein the generator has a first maximum power rating when the engine is operated at the idle speed and a second maximum power rating when the engine is operated at the run speed, and wherein the second maximum power rating is higher than the first maximum power rating.

13. The method of claim 9, wherein converting the voltage provided to power the load from a first frequency to a second frequency includes using an inverter to convert the voltage.

14. The method of claim 9, wherein the first frequency is lower than the second frequency.

15. The method of claim 9, wherein the change to the load is a first detected change to the load, and further comprising switching from operating the engine at the idle speed to operating the engine at the run speed based on a second detected change to the load, and discontinuing converting the voltage provided to the load from the first frequency to the second frequency while the engine is operated at the run speed.

16. A method, comprising:
operating an engine of a generator at an idle speed;
converting a voltage provided by an alternator coupled to the generator to power a load from a first frequency to a second frequency while the generator is operated at the idle speed;
switching from operating the engine at the idle speed to operating the engine at a run speed based on a detected change in the load; and
discontinuing conversion of the voltage from the first frequency to the second frequency when the engine is operated at the run speed.

17. The method of claim 16, wherein the generator is one of a portable generator and a standby generator.

18. The method of claim 16, wherein the engine is an internal combustion engine operating on one of diesel fuel, gasoline, propane, kerosene, and natural gas.

19. The method of claim 16, wherein the generator has a first maximum power rating when the engine is operated at the idle speed and a second maximum power rating when the engine is operated at the run speed, and wherein the second maximum power rating is higher than the first maximum power rating.

20. The method of claim 16, wherein converting the voltage provided to power the load from a first frequency to a second frequency includes using an inverter to convert the voltage.
